(19) United States
(12) Patent Application Publication
(10) Pub. No.: US 2020/0329948 A1
(43) Pub. Date: Oct. 22, 2020

(54) MANUAL DISHWASHER DEVICE AND METHOD OF ASSEMBLING SAME

(71) Applicant: Jo-Anne Simard, Laval (CA)

(72) Inventor: Jo-Anne Simard, Laval (CA)

(21) Appl. No.: 16/388,951

(22) Filed: Apr. 19, 2019

(51) Int. Cl. A47L 17/02; A47L 17/04; A47J 47/20

(52) U.S. Cl. CPC A47L 17/02; A47J 47/20; A47L 17/04

(57) ABSTRACT

A manual dishwasher device comprises a receptacle defining a top opening, a pair of sets of brush bristles each located along opposed inner longitudinal side surfaces of the top opening, with each set having their brush bristles extending oppositely laterally inwardly relative to one another, and a pair of support members extending longitudinally distally from opposed ends of the top opening for support of the device on opposed edge of a sink. The device may have its support members movable between an extended and a retracted position, and the pair of sets of brush bristles removably engaged along the side edges of the top opening. The sets of brush bristles and support members may cooperate to support the receptacle made entirely of flexible material.

### FIELD OF THE INVENTION

The present invention relates generally to dishwasher and, more particularly, to a manual dishwasher device and a method of assembling same.

### BACKGROUND OF THE INVENTION

Manual dishwasher devices are known. These known devices are generally represented by a cylindrical or cubic container having a lid provided with a handle. When the lid is removed, typically, some sort of dish rack and a utensil basket is provided at the bottom of the container for receiving dishes and utensils to be washed. A hose connects a top portion of the lid with the kitchen faucet. A relatively flat and wide shower head covers the inner surface of the lid and is in fluid connection with the hose.

By opening the hot water valve of the faucet, hot water is sprayed through the shower head and on the dishes and utensils in the rack and basket. After a sufficient amount of time, the dishes and utensils are generally clean and can be removed from the devices for drying with a dish towel.

With the manual dishwasher device positioned close to the kitchen sink, a reclosable sink hole along the lower side of the container may be opened to drain the soiled water from the container into the kitchen sink.

Some other models of a manual dishwasher device include a spinnable rack through a rotatable handle along the side of the container, for improving the washing performances of the device.

While these known manual dishwasher devices can generally fulfill the main objective of washing soiled dishes and utensils, they also generally include one or more of the following disadvantages.

For example, they are generally cumbersome since they typically occupy significant space on the kitchen countertop, which has rarely enough to start with.

Furthermore, the use of these known manual dishwasher devices does not guarantee clean dishes and utensils since they essentially rely on sprayed water for cleaning. Often, a second cycle, if not more, is needed.

Furthermore, they generally involve almost as much hand manipulations as a classic dishwashing by hand if you include the manual filling and retrieving of the dishes and utensils from the device, and the occasional washing by hand of stubborn stains on a few dishes and utensils.

Thus, there is a need on the market for an improved manual dishwasher device that minimizes the space occupied by the device, and overall time and manipulations required for washing the dishes and utensils.

In a broad aspect, the present invention provides such an improved manual dishwasher device, and a method of using same.

### SUMMARY OF THE INVENTION

In a broad aspect, the present invention provides a manual dishwasher device.

The manual dishwasher device comprises a receptacle for containing a liquid. The receptacle includes a top opening defined by opposed longitudinal side edges interconnected by opposed end edges, thus forming an open frame.

The receptacle includes a collapsible sidewall extending substantially downwardly from the side edges of top opening, and a bottom wall closing the bottom end of the collapsible sidewall.

The receptacle is selectively movable between a receptacle retracted state, and a receptacle extended state, in which the bottom wall is relatively closer to the top opening when in the receptacle retracted state than in the receptacle extended state.

The manual dishwasher device further comprises a pair of sets of resiliently flexible brush bristles. Each set extends laterally inwardly from oppositely facing inner longitudinal portion of a respective longitudinal side edge of the open frame.

The free ends of the brush bristles of one set of brush bristles end in proximity relative to the free ends of the brush bristles of the opposed set of brush bristles along a longitudinal axis of the top opening.

The manual dishwasher device further comprises a pair of substantially rigid support members. Each support member extends longitudinally distally from a respective transversal end of the open frame.

Furthermore, each support member has an end portion configured for resting on top of a respective one of diametrically opposed top edge portions of a sink so as to support the manual dishwasher device there between.

Thus, with the manual dishwasher device supported on opposed edges of the sink, the receptacle may be extended and filled with a washing solution so as to conveniently wash items such as dish plates, drinking cups, utensils and the likes by inserting and retrieving each item through the opposed brush bristles a sufficient number of times. Preferably, the washing solution contains soap and warm water, or soap and hot water.

In an alternate embodiment of the invention, the manual dishwasher device comprises a receptacle for containing a liquid.

The receptacle is entirely made of a substantially flexible material such as silicone, rubber or a synthetic rubber.

The manual dishwasher device further comprises a top opening defined by opposed longitudinal side edges interconnected by opposed transversal ends, thus forming an open frame.

The receptacle includes a collapsible sidewall extending substantially downwardly from the side edges of the top opening, and a bottom wall closing the bottom end of the sidewall.

Thus, the receptacle is selectively movable between a receptacle retracted state and a receptacle extended state wherein the bottom wall is relatively closer to the top opening when in the receptacle retracted state than in the receptacle extended state.

The manual dishwasher device further comprises a pair of sets of resiliently flexible brush bristles. Each set of brush bristles includes a substantially elongated and rigid base member having a longitudinal side portion from which a plurality of brush bristles extends perpendicularly distally therefrom, and a base member bore extending longitudinally throughout.

Furthermore, the base member of each set of brush bristles is removably engaged in a snug fit relationship in a compatibly shaped groove defined longitudinally along an inner longitudinal surface portion of a respective longitudinal side edge of the top opening such that the brush bristles of each set extend laterally and oppositely inwardly relative to one another.

Preferably, a distal free end portion of the brush bristles of each set of brush bristles at least partially overlap one another along a substantially centered longitudinal axis of the top opening.

The manual dishwasher device further comprises a pair of substantially rigid support members. Each support member has a substantially rigid U-shaped configuration that includes parallelly spaced apart elongated leg members each removably and longitudinally slidably engaged in a respective open frame bore extending longitudinally inwardly relative to opposed longitudinal corner portions of a respective end of the open frame.

Furthermore, each support member has a distal end portion configured for resting on top of a respective one of diametrically opposed top edge portions of a sink so as to support the receptacle there between.

Furthermore, each support member is selectively movable longitudinally between a support member extended position and a support member retracted position relative to a respective end edge of the top opening.

Furthermore, each open frame bore of the open frame is longitudinally in register with a base member bore of a set of brush bristles engaged in a respective groove of the open frame.

Thus, with the base member of each set of brush bristles longitudinally engaged in a respective groove on each side of the top opening, each leg member of each support member is slidably engageable in longitudinally corresponding open frame bore and base member bore respectively.

Thus, the substantially rigid base member engaged in their respective groove, in cooperative relation with the leg members of each substantially rigid support member engaged in their respective open frame bores of the receptacle, provide rigidity to the open frame of the flexible receptacle when the manual dishwasher device is supported on opposed side edges of the sink.

Thus, with the manual dishwasher device supported on opposed edges of the sink, the receptacle may be extended and filled with soap and warm water so as to wash items such as dish plates, drinking cups, utensils and the likes by individually inserting and retrieving each item through the opposed brush bristles a sufficient number of times.

Furthermore, with the flexible receptacle, the removable sets of brush bristles and the removable pair of support members of the manual dishwasher device are in a disassembled state, the latter may be packaged in a substantially compact format allowing economic shipment through parcel mail.

A method of assembling a manual dishwasher device is also provided. The manual dishwasher device includes a substantially flexible receptacle having a top opening defining a pair of opposed longitudinal sides edges, a pair of sets of brush bristles each including a substantially rigid and elongated base member, and a pair of substantially rigid and U-shaped support members each including a pair of parallelly extending leg members.

In a first step, the method of assembly comprises engaging the base member of each one in the pair of sets of brush bristles longitudinally in a groove extending along a longitudinal portion of a respective one in the pair of opposed longitudinal side edges of the top opening.

In a second step, the method of assembly comprises inserting the pair of leg members of each one in the pair of U-shaped support members in a pair of bores extending longitudinally parallelly inwardly through a corresponding pair of end corner portions of the receptacle at each longitudinal end of the top opening, and longitudinally in register through each base member in the pair of sets of brush bristles engaged in the grooves.

Thus, the top opening of the substantially flexible receptacle is substantially rigidly maintained open.

A method of using the manual dishwasher device is also provided.

Other advantages, novel features and alternate embodiments of the present invention will be more apparent from the following drawings and detailed description.

### BRIEF DESCRIPTION OF THE DRAWINGS

FIG. 1, in a top perspective view, illustrates an embodiment of a manual dishwashing device, according to the present invention, here shown having a receptacle in an extended state, and support members in a partially extended position;

FIG. 2, in a top perspective enlarged view, illustrates the portion of the devices shown in the circular section line 11 of FIG. 1;

FIG. 3, in a side elevational view, illustrates the device in FIG. 1;

FIG. 4, in an end elevational view, illustrates the device in FIG. 1;

FIG. 5, in a partial side cross-sectional view, illustrates the portion of the device shown in the circular section line V of FIG. 4;

FIG. 6, in a bottom perspective, exploded view, illustrates the device in FIG. 1, here shown with its receptacle in a retracted state;

FIG. 7, in a bottom perspective, partial view, illustrates the portion of the device shown in the circular section line VII of FIG. 6;

FIG. 8, in a top plan view, illustrates a brush element;

FIG. 9, in an end cross-sectional view, illustrates the brush element along section line IX of FIG. 8;

FIG. 10, in a side elevational view, illustrates the device in FIG. 1;

FIG. 11, in an end cross-sectional view, illustrates the device along section line XI of FIG. 10;

FIG. 12, in a side elevational view, illustrates the device in FIG. 1, here shown having its receptacle being moved from an extended position to a retracted position;

FIG. 13, in a side elevational exploded view, illustrates the device in FIG. 1, here shown with its receptacle in a retracted position.

FIG. 14, in a side elevational view, illustrates a manual dish brush, here shown provided with a closure member at the end of the handle.

FIG. 15, in a side elevational, cross-sectional view, illustrates the manual dish brush of FIG. 14;

FIG. 16, in a partial side elevational view, illustrates the closure member shown in the circular section line XVI of FIG. 14; and

FIG. 17, in a top perspective view, illustrates another embodiment of a manual dishwashing device, according to the present invention, here shown provided with a different type of retractable receptacle.

### DETAILED DESCRIPTION OF THE INVENTION

In a broad aspect, the present invention provides a manual dishwasher device 100, and a method of using same.

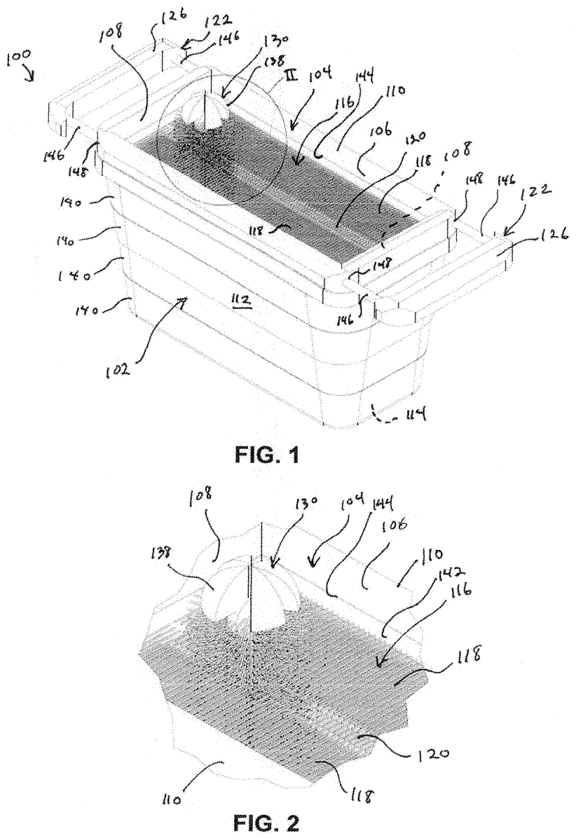

FIG. 1 illustrates an embodiment of a manual dishwasher device 100, according to the present invention.

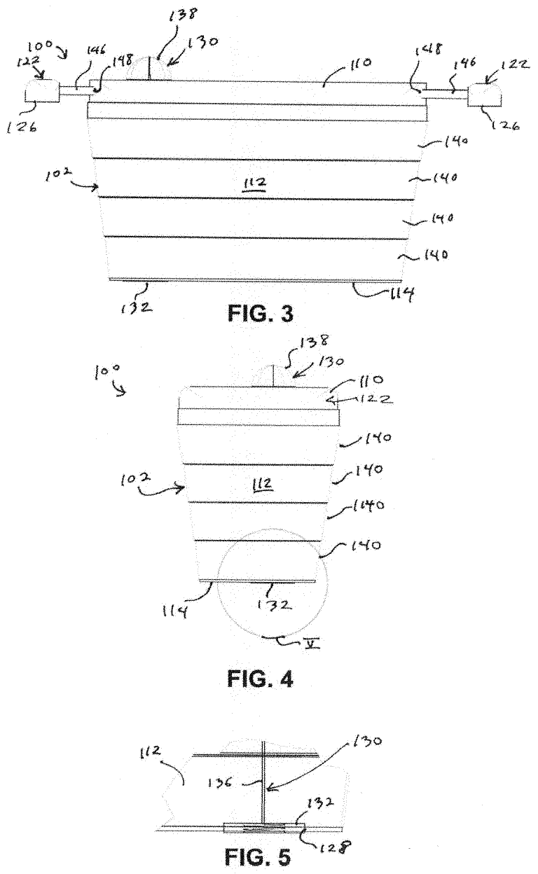

Referring to FIGS. 1 and 3, the manual dishwasher device 100 comprises a receptacle 102 for containing a liquid. The receptacle 102 includes a top opening 104 defined by opposed longitudinal side edges 106 interconnected by opposed end edges 108, thus forming an open frame 110.

The receptacle 102 includes a collapsible sidewall 112 extending substantially downwardly from the side edges of top opening 104, and a bottom wall 114 closing the bottom end of the collapsible sidewall 112.

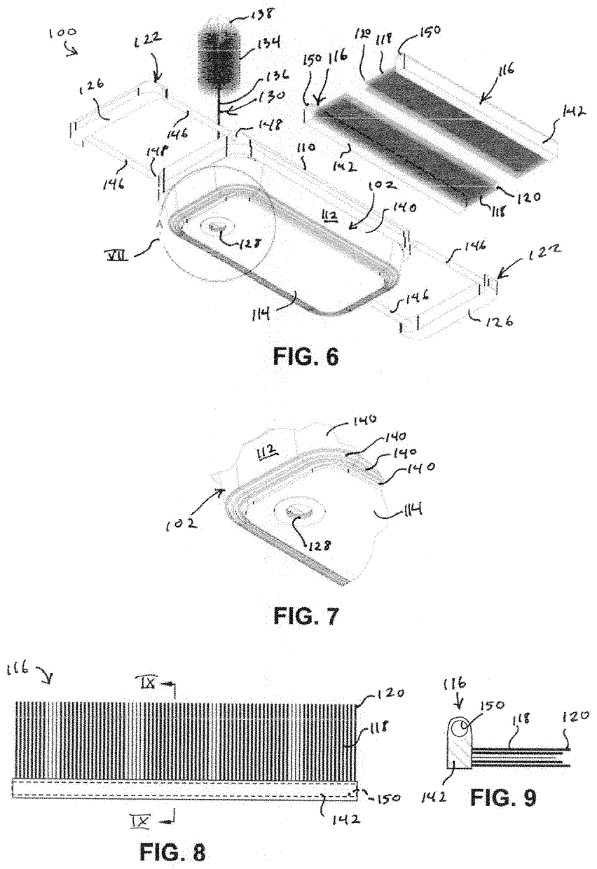

The receptacle 102 is selectively movable between a receptacle retracted state, as illustrated in FIG. 6, and a receptacle extended state, as illustrated in FIG. 1, wherein the bottom wall 114 is relatively closer to the top opening 104 when in the receptacle retracted state than in the receptacle extended state.

The manual dishwasher device 100 further comprises a pair of sets 116 of resiliently flexible brush bristles 118. Each set 116 extends laterally inwardly from oppositely facing inner longitudinal portion of a respective longitudinal side edge 106 of the open frame 110.

The free ends 120 of the brush bristles 118 of one set 116 of brush bristles end in proximity relative to the free ends 120 of the brush bristles 118 of the opposed set 116 of brush bristles along a longitudinal axis of the top opening 104.

The manual dishwasher device 100 further comprises a pair of substantially rigid support members 122. Each support member 122 extends longitudinally distally from a respective transversal end 108 of the open frame 110.

Furthermore, each support member 122 has an end portion 126 configured for resting on top of a respective one of diametrically opposed top edge portions of a sink so as to support the manual dishwasher device 100 there between.

Thus, with the manual dishwasher device 100 supported on opposed edges of the sink, the receptacle 102 may be extended and filled with soap and warm water so as to conveniently wash items such as dish plates, drinking cups, utensils and the likes by inserting and retrieving each item through the opposed brush bristles a sufficient number of times.

In some embodiments of the invention, the top opening 104 has a longitudinal dimension at least slightly greater than the diameter of a dish plate, and a lateral dimension at least slightly greater than the diameter of a drinking cup.

Furthermore, in an extended state, the receptacle 102 has a depth at least slightly greater than the diameter of a dish plate.

Preferably, the top opening 104 has a longitudinal dimension that is between roughly 1 cm and 20 cm greater than the average diameter of a dish plate, and a lateral dimension that is between roughly 1 cm and 20 cm.

Further preferably, in an extended state, the receptacle 102 has a depth dimension of between 15 cm and 30 cm greater than the average diameter of a dish plate.

Other dimensions for the longitudinal and lateral dimensions of the top opening 104, and for the depth dimension of the receptacle 102, are also possible.

Preferably, the receptacle in a top plan view has a substantially rectangular cross-section extending longitudinally.

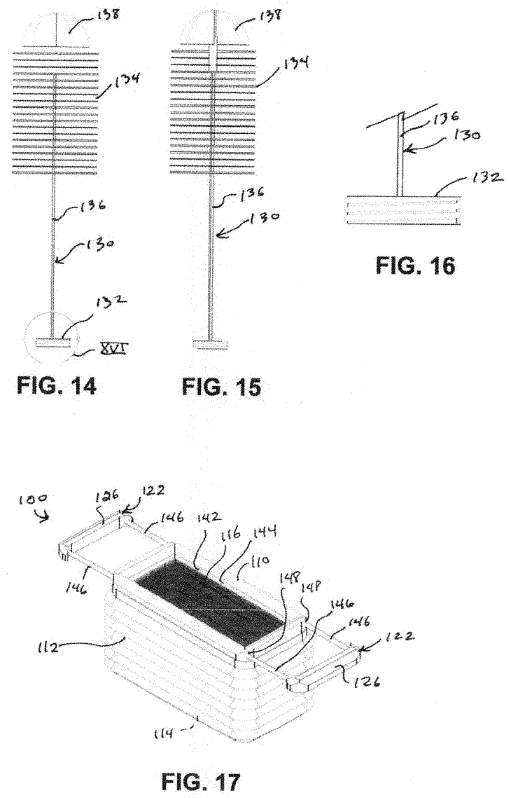

Referring to FIGS. 5 to 7 and 14 to 16 inclusively, in some embodiments of the invention, the receptacle 102 defines a sinkhole 128 extending throughout the bottom wall 114 of the receptacle 102 for draining liquid from the receptacle 102.

Furthermore, the manual dishwasher device 100 further includes a removable closure element 130 for selectively closing the sinkhole 128.

In some embodiments of the invention, as illustrated in FIGS. 6, and 13 to 15, the closure element 130 includes a plug member 132 configured for removably sealably closing the sinkhole 128, and a dish brush 134 having a brush handle 136 extending substantially upwardly away from the plug member 132 and terminating in a dish brush head 138.

In some embodiments of the invention, the closure element 130 is sized and shaped such that, with the plug member 132 sealably engaged in the sinkhole 128, and the dish brush head 138 extending upwardly therefrom, a top portion thereof extends at least partially upwardly through the brush bristles 118, as illustrated in FIGS. 1 and 2.

Thus, a user of the manual dishwasher device 100 may visually locate and grab the dish brush head 138 and remove the closure element 130 from the sinkhole 128, for allowing liquid to be drained from the receptacle.

In some embodiments of the invention, the sinkhole 128 and plug member 132 are both threaded so as to form a sealably threaded junction there between, as best illustrated in FIGS. 7 and 16.

In some embodiments of the invention, the collapsible sidewall 112 and bottom wall 114 of the receptacle 102 are made of a single piece of flexible material.

Preferably, the flexible material is a silicone material. Other types of flexible material are also possible.

Referring, for example, to FIGS. 1, 3 and 6, in some embodiments of the invention, the flexible material of the collapsible sidewall 112 defines a series of downwardly tapering annular rib portions 140.

The annular rib portions 140 are configured for collapsing and extending in a telescopic fashion relative to one another when the receptacle 102 is selectively moved between the receptacle retracted state and the receptacle extended state respectively.

The flexible material is silicone, rubber, or a synthetic rubber.

In some embodiments of the invention, the collapsible sidewall 112 is made of a series of individual downwardly tapering tubular sections 140 selectively telescopically extendible and retractable relative to one another.

Furthermore, tapering tubular sections 140 are sealably engaged to one another when the receptacle 102 is in the receptacle extended state.

Referring to FIG. 17, in some embodiments of the invention, the collapsible sidewall 112 has an accordion configuration capable of selectively adopting an extended and a retracted state.

Referring to FIGS. 1 and 2, in some embodiments of the invention, the distal free ends 120 of one set 116 of brush bristles 118 are located in proximity relative to the distal free ends 120 of the opposed set 116 of brush bristles along a substantially centered longitudinal axis relative to the top opening 104.

Preferably, as best illustrated in FIG. 2, a distal free end portion of the bristles 118 of one set 116 of brush bristles at least partially overlap a distal free end portion of the bristles 118 of the opposed set 116 of brush bristles.

For example, the distal free end portion of the brush bristles 118 of each set 116 of brush bristles may overlap one another a length dimension of between about 1 mm and 10 mm. Other dimensions are also possible.

Referring to FIG. 9, in some embodiments of the invention, the individual bristles 118 within each set 116 of brush bristles have different lengths between one another for improved contact with different surface contours of dishes to be washed.

For example, each bristle 118 within each set 116 of brush bristles may have a difference of length dimension relative to adjacent bristles thereof ranging between about 1 mm and 10 mm. Other difference in length dimension between individual bristles 118 in a same set 116 of brush bristles are also possible.

Referring to FIGS. 6 and 8, in some embodiments of the invention, each set 116 of brush bristles includes a substantially elongated and rigid base member 142 having a longitudinal side portion from which the brush bristles 118 extend perpendicularly distally thereof.

Furthermore, each base member 142 is removably engaged in a compatibly shaped groove 144 extending longitudinally along an inner longitudinal surface portion of a respective longitudinal side edge 106 of the top opening 104.

In some embodiments of the invention, each one in the pair of support members 122 is selectively movable longitudinally between a support member retracted position and a support member extended position, wherein an end portion 126 of each support member 122 is relatively closer to its respective end edge of the top opening 104 when in the support member retracted position than in the support member extended position.

Referring to FIGS. 1 and 6, in some embodiments of the invention, each one in the pair of support members 122 has a substantially rigid U-shaped configuration including parallelly spaced apart elongated leg members 146 longitudinally slidably engaged along a respective longitudinal side edge 106 of the open frame 110.

In some embodiments of the invention, the entire receptacle 102 is made of a substantially flexible material.

Furthermore, each set of brush bristles includes a substantially elongated and rigid base member 142 having a longitudinal side portion from which the brush bristles 118 extend perpendicularly distally thereof.

Furthermore, each base member 142 is removably engaged in an inner longitudinal surface portion of a respective longitudinal side edge 106 of the top opening 104.

Furthermore, each one in the pair of support members 122 has a substantially rigid U-shaped configuration including parallelly spaced apart, elongated leg members 146 each removably and longitudinally slidably engaged in a respective open frame bore 148 extending longitudinally inwardly relative to opposed longitudinal corner portions of a respective longitudinal end of the open frame 110.

Still furthermore, each one in the pair of support members 122 is selectively movable longitudinally between a support member extended position and a support member retracted position relative to a respective end edge of the top opening 104.

In some embodiments of the invention, as best illustrated in FIGS. 1 and 11, the base member 142 of each set 116 of brush bristles is removably engaged in a snug fit relationship in a compatibly shaped groove 144 defined longitudinally along an inner longitudinal surface portion of a respective longitudinal side edge 106 of the top opening 104.

Furthermore, as best illustrated in FIGS. 6, 8, 9 and 11, the base member 142 of each set 116 of brush bristles defines a base member bore 150 extending longitudinally throughout, and in register with, a respective frame bore 148 of the open frame 110.

Thus, with the base member of each set of brush bristles engaged in a respective groove 144 of the open frame 110, each leg member 146 of each support member 122 are longitudinally slidably engageable in longitudinally corresponding open frame bore 148 and base member bore 150 respectively.

Hence, the rigid base member 142 of each set 116 of brush bristles engaged in their respective groove 144 of the receptacle 102, in cooperative relation with the leg members 146 of each rigid support member 122 engaged in their respective bores 148 provide rigidity to the open frame 110 of the flexible receptacle 102 when the manual dishwasher device 100 is supported on opposed side edges of the sink.

Furthermore, with the flexible receptacle 102, the removable sets 116 of brush bristles and the removable pair of support members 122 of the manual dishwasher device 100 in a disassembled state relative to one another, the manual dishwasher device 100 may be packaged in a substantially compact format, thus allowing economic shipment through parcel mail.

This novel arrangement significantly facilitate and reduce the overall cost production of the components of the manual dishwasher device 100, as well as its assembly and shipping to retail stores and online shoppers.

A method of assembling a manual dishwasher device will now be described. The manual dishwasher device includes a substantially flexible receptacle having a top opening defining a pair of opposed longitudinal sides edges, a pair of sets of brush bristles each including a substantially rigid and elongated base member, and a pair of substantially rigid and U-shaped support members each including a pair of parallelly extending leg members.

In a first step, the method of assembly comprises engaging the base member of each one in the pair of sets of brush bristles longitudinally in a groove extending along a longitudinal portion of a respective one in the pair of opposed longitudinal side edges of the top opening.

In a second step, the method of assembly comprises inserting the pair of leg members of each one in the pair of U-shaped support members in a pair of bores extending longitudinally parallelly inwardly through a corresponding pair of end corner portions of the receptacle at each longitudinal end of the top opening, and longitudinally in register through each base member in the pair of sets of brush bristles engaged in the grooves.

Thus, the top opening of the substantially flexible receptacle is substantially rigidly maintained open.

The method of assembly may further comprise the step of longitudinally slidably adjusting at least one in the pair of U-shaped support members relative to the receptacle such that oppositely distally extending portions of each one in the pair of U-shaped support members abut on top of oppositely facing edge portions of a sink.

A method of using the device 100 will now be described. With the receptacle 102 in a retracted state, and the U-shaped support members 122 in a retracted position, the method of use of the device 100 essentially consist of, in a first step, position the U-shaped support members 122 in an extended position and rest the latters on opposed side edges of, typically, a kitchen sink. In a second step, extend the receptacle 102 in an extended state and close the sinkhole 128 of the receptacle 102 using the closure element 130. In a third step, the receptacle 102 may be filled with hot water and dish soap, followed with actually washing and brushing dish and utensil items by individually passing each one once or more times through the brush bristles 118 and into the soaped water in the receptacle 102, thus substantially thoroughly cleaning each item.

Finally, once the dish and utensil items are washed, the soiled water in the receptacle 102 may be drained by removing the closure element 130, followed with retracting the receptacle 102 and the U-shaped support members 122 so as to conveniently stow the device 100 in a compact configuration for future use.

The dish brush 134 of closure element 130 may be advantageously used before filling the receptacle 102 and washing the dishes with the device 100 to remove significant amount of leftovers in the dish plates, or used after having washed the dishes to remove stubborn stains with running water of the faucet.

Further advantageously, after use, the closure element 130 including the dish brush 1134 may by stowed longitudinally sideways within the receptacle 102 when the latter is in a retracted state.

In an alternate embodiment of the invention, the manual dishwasher device 100 comprises a receptacle 102 for containing a liquid.

The receptacle 102 is entirely made of a substantially flexible material such as silicone, rubber or a synthetic rubber.

The manual dishwasher device 100 further comprises a top opening 104 defined by opposed longitudinal side edges interconnected by opposed transversal ends 108, thus forming an open frame 110.

The receptacle 102 includes a collapsible sidewall 112 extending substantially downwardly from the side edges of the top opening 104, and a bottom wall 114 closing the bottom end of the sidewall 112.

Thus, the receptacle 102 is selectively movable between a receptacle retracted state and a receptacle extended state wherein the bottom wall 114 is relatively closer to the top opening 104 when in the receptacle retracted state than in the receptacle extended state.

The manual dishwasher device 100 further comprises a pair of sets 116 of resiliently flexible brush bristles 118. Each set 116 of brush bristles includes a substantially elongated and rigid base member 142 having a longitudinal side portion from which a plurality of brush bristles 118 extends perpendicularly distally therefrom, and a base member bore 150 extending longitudinally throughout.

Furthermore, the base member 142 of each set 116 of brush bristles is removably engaged in a snug fit relationship in a compatibly shaped groove 144 defined longitudinally along an inner longitudinal surface portion of a respective longitudinal side edge 106 of the top opening 104 such that the brush bristles 118 of each set 116 extend laterally and oppositely inwardly relative to one another.

Preferably, a distal free end portion 120 of the brush bristles 118 of each set 116 of brush bristles at least partially overlap one another along a substantially centered longitudinal axis of the top opening 104.

The manual dishwasher device 100 further comprises a pair of substantially rigid support members 122. Each support member 122 has a substantially rigid U-shaped configuration that includes parallelly spaced apart elongated leg members 146 each removably and longitudinally slidably engaged in a respective open frame bore 148 extending longitudinally inwardly relative to opposed longitudinal corner portions of a respective end of the open frame 110.

Furthermore, each support member 122 has a distal end portion 126 configured for resting on top of a respective one of diametrically opposed top edge portions of a sink so as to support the receptacle 102 there between.

Furthermore, each support member 122 is selectively movable longitudinally between a support member extended position and a support member retracted position relative to a respective end edge of the top opening 104.

Furthermore, each open frame bore of the open frame is longitudinally in register with a base member bore of a set of brush bristles engaged in a respective groove of the open frame 110.

Thus, with the base member 142 of each set 116 of brush bristles longitudinally engaged in a respective groove 144 on each side of the top opening 104, each leg member 146 of each support member 122 is slidably engageable in longitudinally corresponding open frame bore 148 and base member bore 150 respectively.

Thus, the substantially rigid base member 142 engaged in their respective groove 144, in cooperative relation with the leg members 146 of each substantially rigid support member 126 engaged in their respective open frame bores 148 of the receptacle 102, provide rigidity to the open frame 110 of the flexible receptacle 102 when the manual dishwasher device 100 is supported on opposed side edges of the sink.

Thus, with the manual dishwasher device 100 supported on opposed edges of the sink, the receptacle 102 may be extended and filled with soap and warm water so as to wash items such as dish plates, drinking cups, utensils and the likes by individually inserting and retrieving each item through the opposed brush bristles 118 a sufficient number of times.

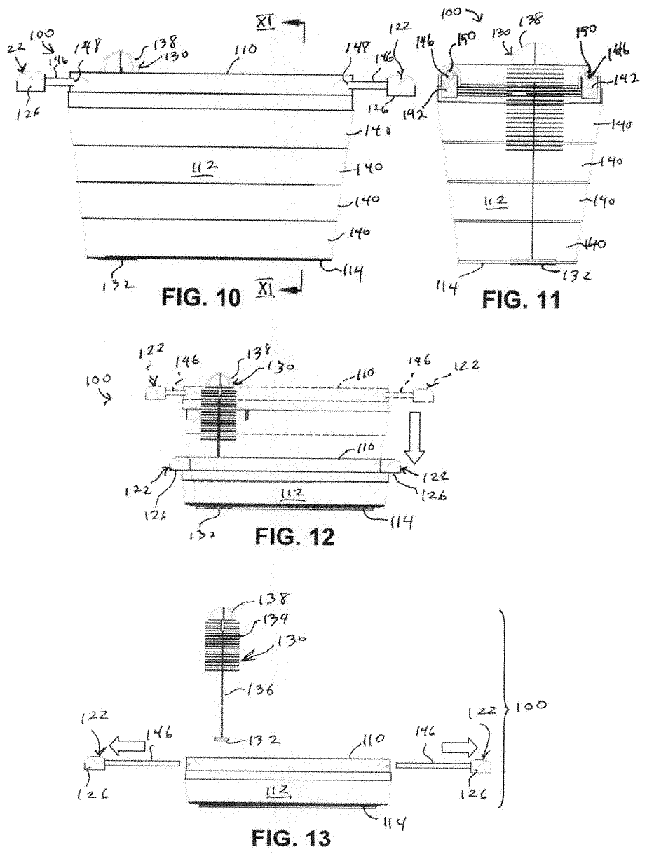

Furthermore, as illustrated in FIGS. 12 and 13, with the flexible receptacle 102, the removable sets 116 of brush bristles and the removable pair of support members 122 of the manual dishwasher device 100 are in a disassembled state, the latter may be packaged in a substantially compact format allowing economic shipment through parcel mail.

Although the present invention has been described hereinabove by way of preferred embodiments thereof, it can be modified, without departing from the spirit and nature of the subject invention.

What is claimed is:

1. A manual dishwasher device, comprising:
a receptacle for containing a liquid, the receptacle including
a top opening defined by opposed longitudinal side edges interconnected by opposed end edges, thus forming an open frame,
a collapsible sidewall extending substantially downwardly from the side edges of the top opening, and a bottom wall closing the bottom end of the collapsible sidewall,
wherein the receptacle is selectively movable between a receptacle retracted state and a receptacle extended state wherein the bottom wall is relatively closer to the top opening when in the receptacle retracted state than in the receptacle extended state;
a pair of sets of resiliently flexible brush bristles, each set extending laterally inwardly from oppositely facing inner longitudinal portion of a respective longitudinal side edge of the open frame and defining free ends,
wherein the free ends of the brush bristles of one set of brush bristles ending in proximity relative to the free ends of the brush bristles of the opposed set of brush bristles along a longitudinal axis of the top opening; and
a pair of support members, each support member extending longitudinally and distally from a respective end edge of the top opening, and
has an end portion configured for resting on top of a respective one of diametrically opposed top edge portions of a sink so as to support the receptacle there between;
wherein, when the manual dishwasher device is supported on opposed edges of the sink, the receptacle can be extended and filled with a washing solution so as to wash items by inserting and retrieving each item through the opposed brush bristles a sufficient number of times.

2. The manual dishwasher device of claim 1, wherein
the top opening has a longitudinal dimension at least slightly greater than the diameter of a dish plate, and a lateral dimension at least slightly greater than the diameter of a drinking cup, and
in an extended state, the receptacle has a depth at least slightly greater than the diameter of a dish plate.

3. The manual dishwasher device of claim 1, wherein the receptacle defines a sinkhole extending throughout the bottom wall of the receptacle for draining the washing solution from the receptacle, and
Includes a removable closure element for selectively closing the sinkhole.

4. The manual dishwasher device of claim 4, wherein the closure element includes
a plug member configured for removably sealably closing the sinkhole, and
a dish brush having a brush handle extending substantially upwardly away from the plug member and terminating in a dish brush head.

5. The manual dishwasher device of claim 5, wherein the closure element being sized and shaped such that, with the plug member sealably engaged in the sinkhole, and the dish brush head extending upwardly therefrom, a top portion thereof is extending at least partially upwardly through the brush bristles so as to allow a user of the manual dishwasher device to visually locate and grab the dish brush head and remove the closure element, thus allowing the washing solution to be drained from the receptacle.

6. The manual dishwasher device of claim 4, wherein the sinkhole and plug member are both threaded so as to form a sealably threaded junction there between.

7. The manual dishwasher device of claim 1, wherein the collapsible sidewall and bottom wall of the receptacle are made of a single piece of flexible material.

8. The manual dishwasher device of claim 7, wherein
the flexible material of the collapsible sidewall defines is a series of downwardly tapering annular rib portions, and
the annular rib portions are configured for collapsing and extending in a telescopic fashion relative to one another when the receptacle is selectively moved between the receptacle retracted state and the receptacle extended state respectively.

9. The manual dishwasher device of claim 1, wherein the collapsible sidewall is made of a series of individual downwardly tapering tubular sections
selectively telescopically extendible and retractable relative to one another, and
sealably engaged to one another when the receptacle is in the receptacle extended state.

10. The manual dishwasher device of claim 1, wherein the collapsible sidewall has an accordion configuration capable of selectively adopting an extended and a retracted state.

11. The manual dishwasher device of claim 1, wherein the distal free ends of one set of brush bristles are located in proximity relative to the distal free ends of the opposed set of brush bristles along a substantially centered longitudinal axis relative to the top opening.

12. The manual dishwasher device of claim 1, wherein a distal free end portion of the bristles of one set of brush bristles at least partially overlap a distal free end portion of the bristles of the opposed set of brush bristles.

13. The manual dishwasher device of claim 1, wherein the individual brush bristles in each set of brush bristles have different lengths between one another for improved contact with different surface contours of dishes to be washed.

14. The manual dishwasher device of claim 1, wherein
each set of brush bristles includes a substantially elongated and rigid base member having a longitudinal side portion from which the brush bristles extend perpendicularly distally, and
each base member is removably engaged in a compatibly shaped groove defined longitudinally along an inner longitudinal surface portion of a respective longitudinal side edge of the top opening.

15. The manual dishwasher device of claim 1, wherein
each one in the pair of support members is selectively movable longitudinally between a support member retracted position and a support member extended position,
wherein an end portion of each support member is relatively closer to its respective end edge of the top opening when in the support member retracted position than in the support member extended position.

16. The manual dishwasher device of claim 17, wherein each one in the pair of support members has a substantially rigid U-shaped configuration including parallelly spaced apart elongated leg members longitudinally slidably engaged along a respective longitudinal side of the open frame.

17. The manual dishwasher device of claim 1, wherein
the entire receptacle is made of a substantially flexible material,
each set of brush bristles includes a substantially elongated and rigid base member having a longitudinal side portion from which the brush bristles extend perpendicularly distally,
each base member is removably engaged in an inner longitudinal surface portion of a respective longitudinal side edge of the top opening,
each one in the pair of support members has a substantially rigid U-shaped configuration including parallelly spaced apart elongated leg members each removably and longitudinally slidably engaged in a respective open frame bore extending longitudinally inwardly relative to opposed end corner portions of a respective end of the open frame, and
each one in the pair of support members is selectively movable longitudinally between a support member retracted position and a support member extended position, relative to a respective end edge of the top opening.

18. The manual dishwasher device of claim 19, wherein
the base member of each set of brush bristles is removably engaged in a snug fit relationship in a compatibly shaped groove defined longitudinally along the inner longitudinal surface portion of a respective longitudinal side edge of the top opening, and
the base member of each set of brush bristles defines a base member bore extending longitudinally throughout, and in register with, a respective frame bore of the open frame,
wherein, with the base member of each set of brush bristles longitudinally engaged in a respective groove on each side of the top opening, each leg member of each support member are slidably engageable in longitudinally corresponding open frame bore and base member bore respectively,
wherein, the rigid base member of each set of brush bristles thus engaged in their respective groove of the receptacle, in cooperative relation with the leg members of each support member cooperatively engaged in their respective open frame bore and corresponding base member bore, provide rigidity to the open frame of the flexible receptacle when the manual dishwasher device is supported on opposed side edges of the sink, and
wherein, with the flexible receptacle, the removable sets of brush bristles and the removable pair of support members of the manual dishwasher device in a disassembled state relative to one another, the manual dishwasher device may be packaged in a substantially compact format, thus allowing economic shipment through parcel mail.

19. A method of assembling a manual dishwasher device, the manual dishwasher device including a substantially flexible receptacle having a top opening defining a pair of opposed longitudinal sides edges, a pair of sets of brush bristles each including a substantially rigid and elongated base member, and a pair of substantially rigid and U-shaped support members each including a pair of parallelly extending leg members, the method comprising:
engaging the base member of each one in the pair of sets of brush bristles longitudinally in a groove extending along a longitudinal portion of a respective one in the pair of opposed longitudinal side edges of the top opening; and
inserting the pair of leg members of each one in the pair of U-shaped support members in a pair of bores extending longitudinally parallelly inwardly through a corresponding pair of end corner portions of the receptacle at each longitudinal end of the top opening, and longitudinally in register through each base member in the pair of sets of brush bristles engaged in the grooves,
whereby the top opening of the substantially flexible receptacle is substantially rigidly maintained open.

20. The method of claim 19 further comprising:
longitudinally slidably adjusting at least one in the pair of U-shaped support members relative to the receptacle such that oppositely distally extending portions of each one in the pair of U-shaped support members abut on top of oppositely facing edge portions of a sink.
